(19) United States
(12) Patent Application Publication
(10) Pub. No.: US 2020/0245809 A1
(43) Pub. Date: Aug. 6, 2020

(54) Method for Detecting an Overload of a Cooking Apparatus with Cooking Products, and Cooking Apparatus

(71) Applicant: RATIONAL AKTIENGESELLSCHAFT, Landsberg am Lech (DE)

(72) Inventors: Juergen KLASMEIER, Landsberg am Lech (DE); Torsten BRINKMANN, Landsberg am Lech (DE); Christine GESCHKE, Landsberg am Lech (DE); Tim REUTER, Landsberg am Lech (DE)

(21) Appl. No.: 16/641,820

(22) PCT Filed: Aug. 21, 2018
(86) PCT No.: PCT/EP2018/072555

§ 371 Date: Feb. 25, 2020

(30) Foreign Application Priority Data
Aug. 25, 2017 (DE) 10 2017 119 485.1

(51) Int. Cl. A47J 36/32; A47J 27/16; A23L 5/10

(52) U.S. Cl. CPC A47J 36/32; A47J 27/16; A23V 2002/00; A47J 2202/00; A23L 5/13

(57) ABSTRACT

A method of detecting an overload of a cooking appliance (10) with food to be cooked is described, in which the food to be cooked is optically detected and/or a cooking chamber humidity profile and/or cooking chamber temperature profile is/are detected and evaluated during an ongoing cooking process in order to draw conclusions about an overload of the cooking appliance (10), taking into account the selected cooking program. A warning signal is output if an overload of the cooking appliance (10) has been detected. Further described is a cooking appliance (10).

The invention relates to a method of detecting an overload of a cooking appliance with food to be cooked and a cooking appliance for cooking food.

Cooking appliances that are used in professional kitchens, canteen kitchens or in restaurant chains usually have a cooking program memory in which a cooking program is stored that can be selected for a particular food to be cooked.

Depending on the food to be cooked, the appropriate cooking program is loaded accordingly, which may comprise a plurality of cooking processes. The cooking processes of the cooking program are executed here by the cooking appliance in a predefined order, so that the desired cooking result is achieved for the food to be cooked.

Cooking appliances of this type may include, inter alia, a steam generator and a heating device, by means of which the humidity and/or the temperature in the cooking chamber can be controlled appropriately. This is generally referred to as cooking chamber atmosphere. Depending on the cooking program selected, the cooking program comprises, for example, a “Steam” cooking step and a “Bake” cooking step, in which a humid or, respectively, a dry cooking chamber atmosphere is set.

Here, the parameters stored in the cooking program may be selected, in particular automatically, depending on the quantity of food introduced and to be cooked, so that the cooking processes in progress are optimized with regard to the charging of the cooking appliance. These parameters are geared, for example, to the setpoint humidity in the cooking chamber, the setpoint temperature in the cooking chamber, the cooking time, the fan speed for circulating the cooking chamber atmosphere, etc. This ensures that an optimum cooking result is achieved even if the cooking appliance is charged or loaded differently, provided that the charge is between a predefined minimum and a predefined maximum load of the cooking appliance. It is known from the prior art to determine a load of the cooking appliance based on the profile of the cooking chamber temperature, in order to adjust the parameters of the ongoing cooking processes in accordance with the load so that a desired cooking result is achieved which is matched to the charge quantity.

However, the adjustment of the parameters can only be effected within the specified limits between the minimum and maximum loads, which is why an overloading of the cooking appliance, which may happen inadvertently during peak operation, for example, may lead to an undesirable cooking result. This, for example, results in an insufficient or absence of browning of the food cooked, a non-typical shape of the food cooked, too small or too large a volume of the food cooked, or too low an internal degree of cooking of the food cooked. In summary, the food cooked does therefore not meet the customer's expectations, which is why the respective food cooked cannot be sold or at least not be sold at full price.

It is only after the cooking process has been completed that the operating company or the person operating the cooking appliance can determine that the food cooked is not of the desired quality. However, it is not possible to retrace or comprehend the reason for the undesirable cooking result. There is therefore a risk that the operating error will be repeated.

It is therefore the object of the invention to provide an effective overload detection means, which allows an overload of the cooking appliance to be detected in a simple manner, so that at least the reason for the undesirable cooking result is comprehensible.

The object is achieved according to the invention by a method of detecting an overload of a cooking appliance with food to be cooked, in which the food to be cooked is optically detected and/or a cooking chamber humidity profile and/or a cooking chamber temperature profile is/are detected and evaluated during an ongoing cooking process in order to draw conclusions about an overload of the cooking appliance, taking into account the selected cooking program, wherein a warning signal is output if an overload of the cooking appliance has been detected.

The basic idea of the invention is that the cooking chamber humidity and/or the cooking chamber temperature, for example, is or are employed to detect an overload of the cooking appliance with food to be cooked. This means that on the basis of the appropriately acquired parameters, it can be detected whether too much food to be cooked, that is, more than the maximum permissible amount of food to be cooked, has been introduced into the cooking appliance, which is equivalent to an operating error of the cooking appliance. Alternatively or in addition, the food to be cooked may be optically detected, for example by means of an optical sensor such as a camera, with the quantity and/or the volume of the food to be cooked being determined in order to draw conclusions about an overload. Should this be the case, that is, should overloading be detected, an appropriate warning signal is output in order to call the attention of the operating person and/or the company operating the cooking appliance. This will provide the person and/or the company operating the cooking appliance at least with the information as to why the cooking result does not meet expectations. Overloading the cooking appliance corresponds to an excessive load of the cooking appliance, which is individual to the food to be cooked and therefore depends on the cooking program selected. Therefore, the warning signal for a first cooking program, for example, is output earlier than for a different cooking program that is used for cooking a different food to be cooked or for preparing the same food in a different way. This is therefore to be understood in consideration of the cooking program selected.

An overloading within the meaning of the present invention is not necessarily related to a weight of the food to be cooked.

Rather, the decisive factors and/or parameters of the food to be cooked are those which have an effect on a cooking chamber atmosphere and/or influence the cooking chamber atmosphere, for example a humidity and/or a temperature, in particular an initial temperature, of the food to be cooked.

For this reason, among others, the overload of the cooking appliance can be detected during the cooking process. A purely weight-dependent overload detection would be provided prior to the start of the cooking process, that is, when the cooking appliance is charged.

An overload detection furthermore differs from a load detection in that the overload detection detects a load of the cooking appliance that can no longer be processed. In other words, in the case of an overload, the cooking appliance cannot derive any process parameters that will lead to a satisfactory cooking result. Usually, process parameters such as time, heat input and the like, for example, are extrapolated as a function of the load detected. In the event of an overloading, extrapolation of the process parameters would still not lead to a satisfactory cooking result.

In this respect, there is also a dependence on the cooking program selected, since the cooking program selected, in particular the associated process parameters, have a value range in which satisfactory cooking results can still be achieved. Overloading also depends on the cooking program, because, for example, some foods to be cooked can be overprocessed more readily than other foods to be cooked. In other words, foods that are cooked using different cooking programs have different sensitivities, so that the warning can be issued at a correspondingly later time.

According to one embodiment, an overloading is to be understood as a combination of different foods to be cooked which require different cooking chamber atmospheres for an optimum cooking process.

A different case of overloading is given, for example, if different foods to be cooked can indeed basically be combined with each other for a common cooking process, but are not arranged in a suitable manner in different insertion levels of a cooking chamber. This means that the various foods to be cooked have been arranged in a non-suitable sequence when viewed over a height of the cooking chamber.

Preferably, the method of detecting an overload is carried out continuously during a cooking process, so that an overload can also be determined while the cooking process is in progress. This may be the case if a food being cooked rises during the cooking process or if a food being cooked releases moisture during the cooking process, etc.

Essentially, the point is that an overloading of the cooking appliance can be detected in a simple manner during the cooking process, so that no additional sensors such as a weight sensor need to be used. The overload can therefore be detected in a simple way by using the sensors already provided, namely a temperature and/or humidity sensor.

As a precautionary measure, however, this may also be effected by means of an optical sensor which optically detects and evaluates the food introduced and to be cooked, in order to draw conclusions in this way about the (total) volume and/or the quantity. For the volume and/or the quantity, threshold values may be stored, which are assigned, for example, to a volume that is still processable by the cooking appliance and/or to a corresponding quantity. Should the threshold value for the volume and/or the quantity be exceeded, a warning signal is output to signal that overloading has occurred. The optical sensor is provided in particular in cooking appliances that automatically detect the food to be cooked and select or at least propose the cooking program in an automated fashion.

In an optimum case, it is even still possible to intervene manually in the cooking process if it has already been started, and to react to the incorrect charging in order to still obtain as acceptable a cooking result as possible. However, this depends on the cooking program selected and the respective food being cooked, since some foods that were cooked using an incorrect cooking process are no longer suitable for consumption. In particular, this is possible provided that the overload is detected, for example optically, during charging of the cooking appliance, because the cooking process has then not yet been started.

The warning signal involved may be an optical and/or an acoustic warning signal. The optical warning signal offers the advantage that the operator of the cooking appliance can be given instructions for action at the same time. The acoustic warning signal can be perceived by the operator of the cooking appliance even if he or she is not in the immediate vicinity of the cooking appliance. The respective warning signal, in particular the acoustic warning signal, is emitted continuously, for example, until an authorized operator of the cooking appliance intervenes.

The warning signal may also be output only at the end of the cooking process, for example in the form of a visual indicator on the display of the cooking appliance.

Alternatively or as a supplement, in addition to the warning signal, a notice may be provided at the end of the cooking process, for example on the display of the cooking appliance, in order to inform the operating company of the cooking appliance accordingly about the incorrect operation.

In general, when the warning signal is output, instructions for action may also be issued on how to now proceed with the food being cooked. In this respect, the operator of the cooking appliance receives appropriate instructions for recooking the batch if possible in such a way that it is consumable.

In general, the cooking program represents the entire cooking process and the corresponding control commands for the cooking appliance, in particular its subassemblies. The cooking processes here are the individual sequences that mostly run one after the other; these may in turn comprise several cooking steps. For example, the “Roast with crackling” cooking program includes at least one “Cook food inside” cooking process and one “Create crackling” cooking process, with the subassemblies of the cooking appliance being controlled differently in the two cooking processes, in particular the cooking chamber temperatures and the cooking chamber humidity being set differently. The individual cooking processes may furthermore comprise several cooking steps, for example with regard to temperature and duration. For example, during the “Cook food inside” cooking process, the cooking appliance may be operated in a first cooking step with a cooking chamber temperature of 200° C. for 10 minutes and in a second cooking step with a cooking chamber temperature of 220° C. for 5 minutes. Another cooking program is, for example, “Crisp up bread rolls”, which comprises at least the “Defrost” and “Brown” cooking processes.

One aspect provides that the warning signal is output if a setpoint value that is individually stored for the selected cooking program is not reached and/or if an actual value exceeds or falls below a threshold value that is individually stored for the selected cooking program. Accordingly, the warning signal may be output due to different deviations from the ideal cooking progress, which, however, have an adverse effect on the cooking result, for example browning and/or the internal degree of cooking. This depends in particular on the cooking process of the cooking program in which the deviation occurs. Here, the relevant setpoint or threshold value depends individually on the cooking program selected. In this respect, the setpoint or threshold value is also loaded when the cooking program is selected.

In particular, the threshold value and/or the setpoint value is/are a temperature value, a humidity value, a time and/or a number. The respective threshold value or setpoint value is stored in the cooking appliance, for example in a cooking program memory, in which the respective cooking program that is executed is also stored. Depending on the threshold or setpoint value, the cooking chamber humidity, the cooking chamber temperature, the cooking process time, the cooking program time and/or the number of repetitions of a loop is/are appropriately compared with the threshold or setpoint value loaded, in order to be able to conclude that the cooking appliance is overloaded, provided that a respective criterion is met. The number may also be the quantity of the respective food to be cooked that has been optically detected, the quantity being determined by means of a control and evaluation unit based on the image recorded.

According to one embodiment, the warning signal is output if a setpoint cooking chamber temperature is not reached in one or more cooking steps of the cooking process, in particular if the setpoint cooking chamber temperature is not reached in a number of cooking steps that is stored as a threshold value. This allows the conclusion to be drawn about an overload of the cooking appliance because the heat absorption by the food being cooked is too high, so that the corresponding setpoint cooking chamber temperature is not reached. Such a deviation may have an adverse effect on the browning of the food being cooked.

A further aspect provides that the warning signal is output if a setpoint cooking chamber temperature is not reached after a time stored as a setpoint value. This means that a minimum cooking chamber temperature is provided, which is to be reached after a predetermined time. If this is not the case, it can be concluded that there is an overload of the cooking appliance, since the heat absorption by the food introduced and being cooked is too high, in particular by the quantity of food being cooked. This condition is important in particular for products that should have an actual temperature by a specific point in time at the latest. These may involve poultry, baked products with fillings or similar products. Such a deviation may have a negative impact on the internal degree of cooking of the food being cooked, which is especially problematic in the case of poultry.

In accordance with a further aspect, the warning signal is output if, after loading, an actual cooking chamber temperature falls below a cooking chamber temperature defined as a threshold value. This means that the heat absorption of the food introduced and to be cooked is so high that the thermal energy in the cooking chamber drops correspondingly (suddenly), which is reflected in a reduced cooking chamber temperature, among other things. If the cooking chamber temperature falls below the relevant threshold value, it can also be concluded that the cooking appliance has been overloaded.

According to a further embodiment, the warning signal is output if a setpoint humidity is not reached in one or more cooking steps of the cooking process, in particular if the setpoint humidity is not reached in a number of cooking steps that is stored as a threshold value. The humidity absorption of the food introduced and to be cooked is therefore so high that it can be concluded that the cooking appliance has been overloaded, provided that the food to be cooked is dry and is intended to be steamed, for example.

In particular, the warning signal is output if a setpoint humidity is not reached after a time stored as a setpoint value. The period of time until the desired setpoint humidity can be reached may also permit a conclusion to be drawn about the overloading of the cooking appliance. However, this depends on the food to be cooked and the cooking program that has been selected accordingly, as already discussed. Too low a humidity level only indicates that the cooking appliance is overloaded when the food to be cooked involved is “dry” or is to be moistened.

On the other hand, a warning signal may be output if an actual humidity is above a humidity defined as a threshold value. In the case of food to be cooked that is to be dried or an appropriately selected cooking program, the actual humidity of the cooking chamber is intended to be below an appropriate threshold value. If this is not the case, this suggests that the cooking appliance has been overloaded with the corresponding food to be cooked (that is moist or to be dried). Veal sausages, for example, will burst open, as a result of which the cooking chamber humidity will increase further, in particular abruptly, due to the inherent moisture content of the veal sausages. This may lead to a chain reaction, in which all of the food to be cooked that has been placed in the cooking appliance would be damaged, that is, the entire batch.

A further embodiment provides that the warning signal is output if the number of dehumidification intervals is above a value stored as a threshold value. The dehumidification intervals may be initiated in an automated manner by a control and evaluation unit of the cooking appliance, provided the actual humidity of the cooking chamber atmosphere is above a threshold value. If the dehumidification intervals have to be carried out correspondingly frequently in order to reduce the actual humidity, it can also be concluded that the cooking appliance is overloaded because the food introduced and being cooked releases more moisture than is intended as a maximum.

A further aspect provides that the cooking appliance is placed in a locked state when the warning signal is output, so that only an authorized operator can unlock the cooking appliance. The authorized operator may be a store manager or a company operating the cooking appliance, who or which is informed accordingly of the incorrect operation of the cooking appliance by an employee (operator of the cooking appliance). This may be effected by means of the warning signal or an indication coupled to the warning signal. At the same time, an appropriate instruction for action may be issued on how to proceed with the food being cooked.

In particular, the reason for the warning signal is logged, so that the reason is output directly or on request. The authorized operator, for example the store manager, therefore has the possibility to learn about the reason for the abort of the cooking process or the output of the warning signal. This allows an appropriately targeted training of the staff operating the cooking appliance to be performed if this is considered necessary.

Furthermore, the reason for the warning signal may be transmitted via a communication interface to a central unit which is interconnected with a plurality of cooking appliances, so that a statistical survey for a plurality of cooking appliances is possible. If the same or similar error indications from a branch store or a chain accumulate, the head office may initiate appropriate measures, for example training measures tailored to requirements. If, for example, an overload of the cooking appliance occurs more frequently with a particular food being cooked, the staff operating the cooking appliance may be selectively trained with regard to this food to be cooked.

The food to be cooked may be optically detected when it is introduced into the cooking chamber and/or during the cooking process in the cooking chamber, in particular by means of an optical sensor such as a camera. This means that the overloading can be detected before the cooking process is started, so that it is ensured that the overload is detected in time.

The optical sensor may be arranged on a door, in particular the frame thereof, or on the housing of the cooking appliance, so that the optical sensor is not exposed to the temperatures occurring during operation. Here, the detection range of the optical sensor is, for example, in an area in front of the cooking chamber that is used to load the cooking appliance. The optical sensor may also be assigned to the cooking chamber from the outside, in particular through a pane provided in the door, that is, it may have a corresponding detection area to optically detect the food to be cooked that has been placed in the cooking chamber, in particular during the cooking process.

The optical sensor may be arranged laterally of, above or below a corresponding cooking chamber opening. Alternatively, the optical sensor may be arranged within the cooking chamber and constructed to be appropriately resistant or robust.

The control and evaluation unit, which receives the information captured by the optical sensor, is therefore capable of determining the quantity and/or the caliber of the food being cooked, without having to rely on the input of information from the user. The determined quantity and/or the caliber of the introduced food being cooked is then evaluated by an overload detection means of the cooking appliance, taking into account the selected cooking program, in order to draw conclusions about an overload of the cooking appliance.

In addition to the warning signal, the cooking appliance may be placed in a locked state so that the cooking process cannot be started. This provides appropriate protection for the food to be cooked, provided the cooking process has not yet been started.

Furthermore, according to the invention a cooking appliance for cooking foods to be cooked is provided, including a cooking chamber, a cooking program memory, a sensor unit, and an overload detection means, the sensor unit including an optical sensor, a temperature sensor and/or a humidity sensor in order to optically detect the food to be cooked, to detect the temperature in the cooking chamber and/or the humidity in the cooking chamber, wherein at least one individual cooking program that is matched to the food to be cooked is stored in the cooking program memory, the cooking program having at least one threshold value and/or setpoint value assigned to it, and wherein the overload detection means is configured to detect an overload, taking into account the detected food to be cooked, the detected temperature in the cooking chamber and/or the detected humidity in the cooking chamber as well as the selected cooking program, based on the assigned threshold value and/or setpoint value.

Using the cooking appliance, it is therefore possible for an excessive load on the cooking appliance to be detected, that is, an overload of the cooking appliance with food to be cooked, which would result in an undesirable cooking result. Here, for example, the cooking chamber humidity and/or the cooking chamber temperature are employed as detection parameters for the overload of the cooking appliance. Alternatively or additionally, the food to be cooked may be optically detected, for example to determine the quantity of food to be cooked. The respective overload can thus be individually detected in a simple manner as a function of the selected cooking program and the associated food that has been introduced and is to be cooked.

In particular, the cooking appliance is configured to carry out a method of the type mentioned above. The advantages and characteristics mentioned above are apparent analogously for the cooking appliance.

In general, the cooking appliance may be provided in a supermarket with an affiliated bakery shop or may be operated as an automatic baking machine in the supermarket. The supermarket may be part of a chain so that, accordingly, several supermarkets equipped with such cooking appliances are provided. Furthermore, rather than in a supermarket, the cooking appliance may be provided in a bakery, a store, a canteen and/or a restaurant, each of which may be part of a chain.

For example, the cooking appliances can communicate with each other and/or with a central unit in order to exchange protocols, which allows the need for additional training for supermarket staff, that is, the operators of the cooking appliance, to be identified.

Further advantages and characteristics of the invention will be apparent from the following description and the drawings, to which reference is made and in which:

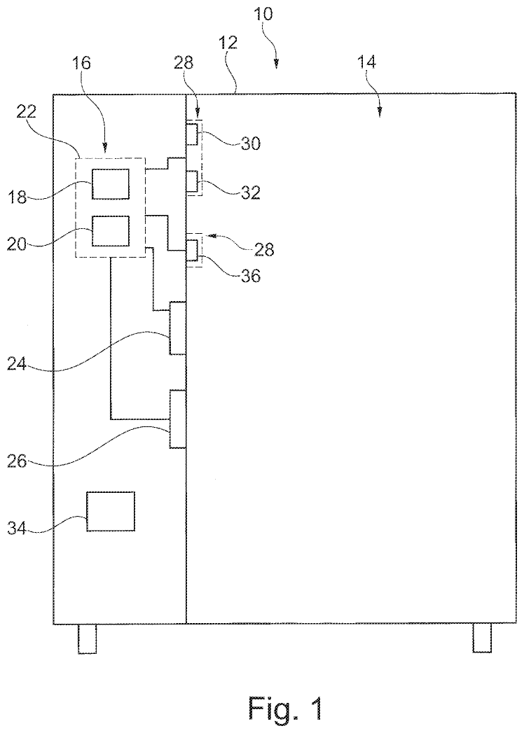

FIG. 1 shows a schematic view of a cooking appliance according to the invention; and

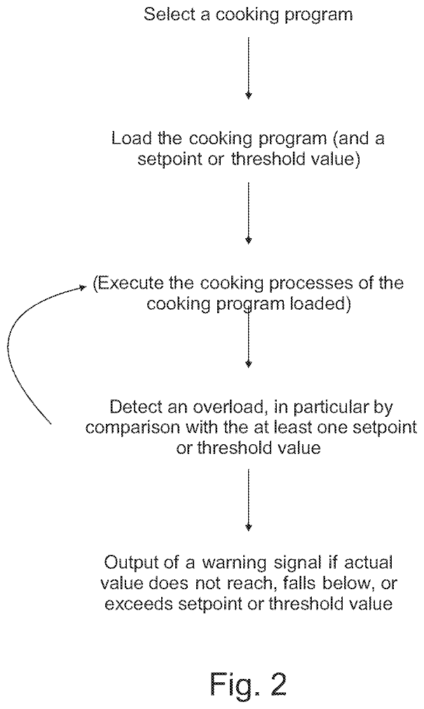

FIG. 2 shows a flowchart that illustrates the method according to the invention.

FIG. 1 shows a cooking appliance 10 having a housing 12 which comprises a cooking chamber 14 in which food to be cooked is cooked.

The cooking appliance 10 further includes an electronics installation chamber 16, which is also accommodated in the housing 12. Provided in the electronics installation chamber 16 are, inter alia, a cooking program memory 18 and an overload detection means 20, which may be part of a control and evaluation unit 22.

The cooking appliance 10 further comprises a steam generator 24 and a heating device 26, by means of which an appropriate cooking chamber atmosphere is produced depending on the selected cooking program and/or the cooking processes to be executed by the cooking program.

The cooking chamber 14 furthermore has a sensor unit 28 assigned to it, which in the embodiment shown comprises a temperature sensor 30 and a humidity sensor 32.

The temperature sensor 30 may be used to sense the cooking chamber temperature, whereas the humidity sensor 32 is provided to sense the humidity in the cooking chamber 14, which is also referred to as cooking chamber humidity.

With reference to FIG. 2, it will now be explained how the cooking appliance 10 carries out a method according to the invention in order to draw conclusions, based on the cooking program selected, about an overload of the cooking appliance 10 with regard to the food to be cooked.

The user of the cooking appliance 10 loads the cooking appliance 10, in particular the cooking chamber 14, with food to be cooked. Depending on the food to be cooked, the user of the cooking appliance 10 selects a cooking program matched thereto, which is stored in the cooking program memory 18.

Selecting the cooking program causes correspondingly stored threshold and/or setpoint values to be loaded, among other things, on the basis of which the overload detection means 20 of the cooking appliance 10 can determine an overload of the cooking appliance 10 during the cooking process.

In particular, the overload detection means 20 determines the stored threshold and/or setpoint values continuously during the cooking process, so that an overload can still be detected even during the cooking process. This refers both to scenarios in which an additional load is placed in the cooking chamber 14 during an already started cooking process, and to scenarios in which a cooking chamber atmosphere changes in an unfavorable way during the cooking process. This may be the case if a food being cooked changes its volume during the cooking process or releases or absorbs a relatively large amount of moisture.

In general, the overloading should be detected as early as possible, so that the food being cooked can at best still be removed and saved.

As soon as the cooking program 18 has been started, the appropriate cooking processes and the respective cooking steps are executed.

Using the sensor unit 28, that is, the temperature sensor 30 and the humidity sensor 32, the cooking chamber temperature profile and the cooking chamber humidity profile are captured and evaluated in order to draw conclusions about an overload of the cooking appliance 10.

In doing so, the respectively captured humidity and/or temperature values are compared with the setpoint and/or threshold values individually stored for the selected cooking program in order to determine whether or not the respectively stored setpoint value is reached and/or whether the captured value exceeds or falls below the stored threshold value. If this is the case, there is an overload of the cooking appliance 10.

This is also referred to as a cooking process-specific detection of an overload, since cooking process-specific parameters are made use of for overload detection.

If there is an overload of the cooking appliance 10, a warning signal is output.

An overload may be determined, for example, if a setpoint cooking chamber temperature that is stored in the cooking program is not reached in one or more cooking steps of the cooking process. Therefore, respective setpoint cooking chamber temperatures are stored for the individual cooking processes of the cooking program, in particular their cooking steps. An overloading can also be determined, for example, in that the respectively desired setpoint cooking chamber temperature is not reached in a number of cooking steps that is stored as a threshold value. In this respect there is a certain tolerance since a warning signal is not already output the first time, but only when the number of cooking steps that is stored as a threshold value is reached in which the setpoint cooking chamber temperature was not reached.

Alternatively or additionally, the warning signal may be output if the setpoint cooking chamber temperature has also not been reached after a time stored as a setpoint value has elapsed. Insofar, the setpoint value is a time specification that is compared with the time of the cooking program or of the cooking process.

Further, provision may be made alternatively or additionally for the warning signal to be output if an actual cooking chamber temperature falls below a cooking chamber temperature defined as a threshold value after loading the cooking appliance 10. The corresponding drop in temperature indicates that too large a quantity of chilled food to be cooked has been introduced. At least the quantity is above the maximum load limit, so that an overloading of the cooking appliance 10 has taken place, as a result of which the actual cooking chamber temperature has dropped correspondingly heavily.

Furthermore, as an alternative or in addition, an overload of the cooking appliance 10 can be detected based on the data captured by the humidity sensor 32.

For example, a warning signal is output even if a setpoint humidity, which is also stored in the corresponding cooking program, is not reached in one or more cooking steps of the cooking process. A certain tolerance may be provided here as well, so that the warning signal is only output when the setpoint humidity was not reached in a number of cooking steps that is stored as a threshold value.

Alternatively or additionally, the warning signal is output if the setpoint humidity was also not reached after a preset time. The time stored accordingly thus constitutes a setpoint value up to which the setpoint humidity must be reached at the latest. The time applied may be the time of the entire cooking program, of a cooking process or of a cooking step.

The actual humidity of the cooking chamber 14 may also be made use of to detect an overload, provided that the actual humidity for particular cooking programs is above a humidity defined as a threshold value. This is of significance, for example, for cooking programs and corresponding foods to be cooked that are moist and are to be dried by means of the cooking appliance 10 or the selected cooking program. A correspondingly high actual humidity is therefore indicative of an overload of the cooking appliance 10.

Should the cooking appliance 10 have an automated dehumidification, a warning signal can be output if the number of dehumidification intervals is above a correspondingly stored value, which therefore constitutes a threshold value. As soon as a measured actual humidity is above a permissible humidity, a dehumidification is performed in an automated manner. If these dehumidification processes are carried out very often, that is, above a threshold value, it can then be concluded that there is an excessive humidity in the cooking chamber 14, which is connected to an overload of the cooking appliance 10.

Irrespective of the reason for outputting the warning signal, the cooking appliance 10 can be automatically put into a locked state when the warning signal is output, so that only an authorized operator of the cooking appliance 10 can unlock it again, for example the store manager. This ensures that the store manager is informed that an incorrect operation has occurred, namely, that the cooking appliance 10 has been overloaded, which is the reason for the reduced quality of the food being cooked or the cooking process/program being aborted.

The particular reason why the warning signal was output can be logged with the cooking appliance 10, so that the respective reason can be reviewed by the authorized operator. The reason may be displayed directly on a display of the cooking appliance 10 or may only be output on request, if this is desired.

In this way, it can be retraced later why the food cooked did not achieve the desired cooking result, because in fact there was an overload. In other words, the operator of the cooking appliance 10 ignored the operating instructions and overloaded the cooking appliance 10.

Furthermore, the warning signal may not be output until the end of the cooking process/program. Alternatively, in addition to the warning signal, an appropriate indication is provided at the end of the cooking process/program to inform the authorized operator, for example the store manager.

The cooking appliance 10 may generally be a connective cooking appliance 10, that is, a cooking appliance 10 having at least one communication interface 34 via which the cooking appliance 10 can communicate.

The communication interface 34 may be an Internet interface, for example a WLAN or LAN interface, so that the cooking appliance 10 can communicate in a simple manner with a remotely located central unit, in particular a central processing unit.

Accordingly, the cooking appliance 10 is configured to transmit the reason for the output of the warning signal to the central unit, which is additionally networked with further cooking appliances situated at other locations. This allows a statistical survey to be carried out involving a plurality of cooking appliances 10 as well as the operation thereof in order to draw conclusions about problems in the operation of the cooking appliance or appliances 10. This allows needs-oriented additional training to be identified and carried out accordingly in order to remove recurring operating errors.

The plurality of cooking appliances 10 and the central processing unit form a corresponding system.

The cooking appliance 10 further comprises a further sensor unit 28, which comprises an optical sensor 36 in the form of a camera, which is connected to the control and evaluation unit 22, in particular the overload detection means 20. This sensor unit 28 can be used for performing an optical overload detection.

The camera 36 takes images of the food to be cooked when it is placed in the cooking chamber 14 or has already been placed in the cooking chamber 14, that is, for example during the cooking process. The image taken accordingly is forwarded to the control and evaluation unit 22 for evaluation, which then determines the quantity and/or the volume or the caliber of the food introduced and to be cooked, by means of known image recognition algorithms, for example an edge detection algorithm.

Subsequently, the control and evaluation unit 22, in particular the overload detection means 20, compares the information extracted from the images with data stored in the cooking program memory 18 for the individually selected cooking program, i.e. with a stored threshold or setpoint value. To this end, the overload detection means 20 accesses the cooking program memory 18 to obtain the respective threshold and/or setpoint values. This allows an overload of the cooking appliance 10 to be detected if the quantity exceeds the setpoint value individually stored for the selected cooking program.

In case an overload has been detected, the cooking appliance 10 outputs a corresponding warning signal, as has already been described based on the cooking chamber humidity profile and/or the cooking chamber temperature profile.

The further, previously described sequences of the cooking process-specific detection can be applied analogously to the optical overload detection of the cooking appliance 10.

The optical detection of the overload allows the overload to be detected before the respective cooking process of the cooking program loaded is started; see FIG. 2. Accordingly, the food to be cooked can still be saved by not starting the cooking process.

In particular, the cooking appliance 10 is locked by the control and evaluation unit 22 so that the cooking process cannot be started. The cooking appliance 10 then has to be first released by an authorized operator of the cooking appliance 10.

This makes it possible to easily determine an overload of the cooking appliance 10 with food to be cooked, as a result of which the reason for the inferior quality of the food being cooked can be identified in a simple manner.

Furthermore, the need for appropriate additional training can be determined in this way in a simple and targeted manner.

1. A method of detecting an overload of a cooking appliance with food to be cooked, in which at least one step from the following group is selected:
the food to be cooked is optically detected;
a cooking chamber humidity profile is detected; or
a cooking chamber temperature profile is detected,
and evaluated during an ongoing cooking process in order to draw conclusions about the overload of the cooking appliance, taking into account the selected cooking program, wherein a warning signal is output if the overload of the cooking appliance has been detected.

2. The method according to claim 1, characterized in that the warning signal is output if a setpoint value that is individually stored for the selected cooking program is not reached and/or if an actual value exceeds or falls below a threshold value that is individually stored for the selected cooking program.

3. The method according to claim 2, characterized in that at least one of the threshold value and the setpoint value are a temperature value, a humidity value, a time or a number.

4-16. (canceled)

17. The method according to claim 1, characterized in that the warning signal is output if a setpoint cooking chamber temperature is not reached in one or more cooking steps of the cooking process.

18. The method according to claim 17, characterized in that the warning signal is output if the setpoint cooking chamber temperature is not reached in a number of cooking steps that is stored as a threshold value.

19. The method according to claim 1, characterized in that the warning signal is output if a setpoint cooking chamber temperature is not reached after a time stored as a setpoint value.

20. The method according to claim 1, characterized in that the warning signal is output if, after loading, an actual cooking chamber temperature falls below a cooking chamber temperature defined as a threshold value.

21. The method according to claim 1, characterized in that the warning signal is output if a setpoint humidity is not reached in one or more cooking steps of the cooking process.

22. The method according to claim 21, characterized in that the warning signal is output if the setpoint humidity is not reached in a number of cooking steps that is stored as a threshold value.

23. The method according to claim 1, characterized in that the warning signal is output if a setpoint humidity is not reached after a time stored as a setpoint value.

24. The method according to claim 1, characterized in that the warning signal is output if an actual humidity is above a humidity defined as a threshold value.

25. The method according to claim 1, characterized in that the warning signal is output if the number of dehumidification intervals is above a value stored as a threshold value.

26. The method according to claim 1, characterized in that the cooking appliance is placed in a locked state when the warning signal is output, so that only an authorized operator can unlock the cooking appliance.

27. The method according to claim 1, characterized in that a reason for the warning signal is logged, wherein the reason is output directly or on request.

28. The method according to claim 1, characterized in that a reason for the warning signal is transmitted via a communication interface to a central unit which is interconnected with a plurality of cooking appliances, whereby a statistical survey for a plurality of cooking appliances is possible.

29. The method according to claim 1, characterized in that the food to be cooked is optically detected for at least a period of time between when it is introduced into the cooking chamber and completion of the cooking process in the cooking chamber.

30. The method according to claim 29, characterized in that the food to be cooked is optically detected by an optical sensor.

31. A cooking appliance for cooking foods to be cooked, comprising a cooking chamber, a cooking program memory, a sensor unit, and an overload detection circuit, wherein the sensor unit comprises at least one of: an optical sensor; a temperature sensor; and a humidity sensor, in order to optically detect the food to be cooked, to detect the temperature in the cooking chamber and/or the humidity in the cooking chamber, wherein at least one individual cooking program that is matched to the food to be cooked is stored in the cooking program memory, the cooking program having at least one of a threshold value or a setpoint value assigned to it, and wherein the overload detection circuit is configured to detect an overload, taking into account an output of the sensor unit as well as the selected cooking program, based on the threshold value or setpoint value assigned.

32. The cooking appliance according to claim 31, characterized in that the cooking appliance is configured to receive output from the sensor unit and evaluate during an ongoing cooking process in order to draw conclusions about the overload of the cooking appliance, taking into account the selected cooking program, wherein a warning signal is output if the overload of the cooking appliance has been detected.
